(19) United States
(12) Patent Application Publication
(10) Pub. No.: US 2005/0010952 A1
(43) Pub. Date: Jan. 13, 2005

(54) System for learning language through embedded content on a single medium

(76) Inventors: Michael J.G. Gleissner, Hong Kong (HK); Mark S. Knighton, Santa Monica, CA (US); Todd C. Moyer, Los Angeles, CA (US); Peter J. DeLaurentis, Marina Del Rey, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/899,537

(22) Filed: Jul. 26, 2004

Related U.S. Application Data
(62) Division of application No. 10/705,186, filed on Nov. 10, 2003.
(62) Division of application No. 10/356,166, filed on Jan. 30, 2003.

(51) Int. Cl. H04N 5/445; G06F 3/00; G06F 7/00; G06F 13/00; G06F 17/00; H04N 7/16

(52) U.S. Cl. 725/46; 725/135; 725/34

(57) ABSTRACT

Learning system using pre-existing entertainment media such as feature films on DVD or music or CD in connection with augmented language-learning content stored in a companion file. A player for viewing or listening the augmented content and the entertainment media. The player may include features such as parental control, position tracking, and an inference engine.

### CROSS-REFERENCE TO RELATED APPLICATION

The application is a divisional of patent application Ser. Nos. 10/356,166 10/705,186, filed Nov. 10, 2003, by Michael J. G. Gleissner, et al., entitled “SYSTEM FOR LEARNING LANGUAGE THROUGH EMBEDDED CONTENT ON A SINGLE MEDIUM.”

### FIELD OF THE INVENTION

The invention relates to media management and language learning tools. Specifically, the invention relates to a set of media management tools that use audio, video and text associated with entertainment content to provide enhanced services for accessing text and information related to audio and/or video content and to control access to the content.

### BACKGROUND

Audio and/or video content, such as CD's, DVDs, audio cassettes, video cassettes and similar media offer content such as music, movies, television shows, radio shows, and similar content. Playback of most media is limited to presentation of recorded material on the media. For example, a user listening to a music CD may use a compact disc player or similar device to listen to the recorded audio. The user's options are typically limited to the selection of tracks, rewinding, fast forwarding and pausing.

Most media materials are produced for entertainment purposes. These materials are not designed to be conducive to learning a language used in the materials. This entertainment material is inaccessible to beginning and intermediate learners because these materials are too quickly paced and laden with idioms, slang and unconventional sentence structure.

These entertainment materials may also contain material that is unsuitable for some audiences such as children. Parents must directly supervise or limit viewing or listening to such materials.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a diagram of an audio and/or video playback system.

FIG. 2A is an illustration of a playback interface.

FIG. 2B is an illustration of an audio player.

FIG. 3 is a flowchart of an audio and/or video playback speed adjustment system.

FIG. 4 is a flowchart of an audio and/or video playback augmentation system.

FIG. 5 is a diagram of a companion source format.

FIG. 6 is a flowchart of a content control system.

FIG. 7 is an illustration of a content control interface.

FIG. 8 is a flowchart of an inference engine.

FIG. 9 is a flowchart of a memory pause function.

### DETAILED DESCRIPTION

In one embodiment, a set of audio and/or video playback enhanced features include additional content for original content stored on a portable media or accessible over a network or broadcast. Enhanced features may include language learning, content controls, an inference engine to adapt the additional content to the needs of a user and a playback position saving function. These enhanced features may be used with entertainment content such as music, movies, television shows, audio books, trivia, commentary, and similar content. The entertainment content may be passively playable. As used herein the term passively playable media or content refers to content that does not require the user to interact with the content during the typical playback. For example, a music CD may be passively playable, because it does not require user interaction during playback unless the user wants to skip a track or stop the playback. These features may utilize additional content, including data stored in companion files. The companion files may be stored on the same media, separate media or distributed using the same medium or different medium as the entertainment content.

In one embodiment, the enhanced features may be used with an interactive audio and/or video language learning system that includes a player software application to allow a user to play a CD, DVD or a similar audio and/or video media containing entertainment material (e.g., a music or feature film) with augmented features and additional content that assist in the learning of a language. As used herein “or” is intended to have its non-exclusive meaning, an “either or” construction is used if the “or” is intended to be exclusive. Augmented features and additional content may include a transcription in a language to be learned, language learning tools such as dictionaries, grammar information, phonetic pronunciation information and similar language related information. The player application system uses a companion file containing the additional content and support for augmented features that may be stored separately from or combined with the associated entertainment material. The companion file contains the information necessary to create augmented features for the entertainment material that may be geared toward language learning.

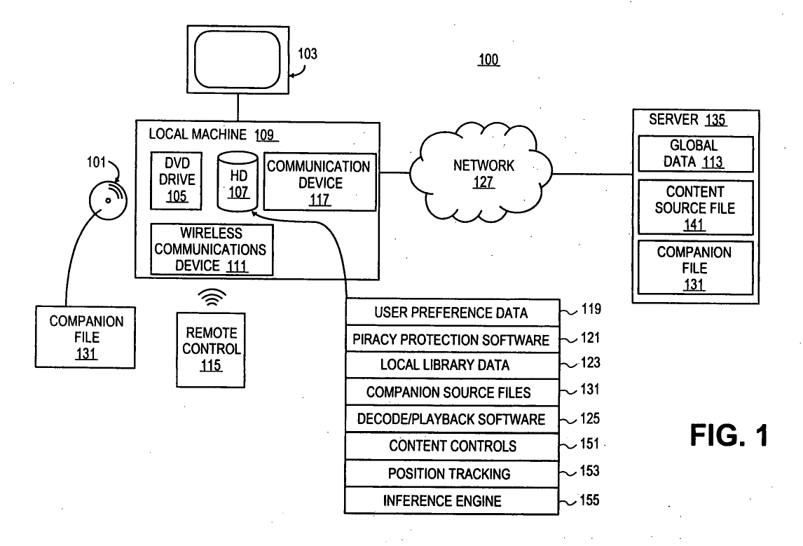

FIG. 1 illustrates a system 100 that enables a user to view or listen to audio and/or video content stored on media 101 using local machine 109 and display device 103. A local machine 109 may be a desktop or laptop computer, an Internet appliance, a console system (e.g., the Xbox® manufactured by Microsoft® Corporation), DVD player, specialized device, or similar device. An audio and/or video player incorporating the enhanced features may access and play audio and/or video content from a random access or sequential storage device 105 attached to local machine 109 (e.g., on DVD, CD, hard drive or similar mediums) or via a remote server 135 and associates audio and/or video content thereon with a companion file 131 that provides the additional content to augment the audio and/or video content.

In one embodiment, companion file 131 may be independent of or integral to audio and/or video content and may be sourced from a separate medium, the same medium, or similar configuration. This system may be used to facilitate language learning using off-the-shelf CDs, DVDs and similar media. In various embodiments, the random access storage media storing audio, video and similar content may be one of a CD, DVD, magnetic disk, optical storage medium, local hard disk file, peripheral device, solid state memory medium, network-connected storage resource or Internet-connected storage resource. In another embodiment, the audio and/or video content may be available to a user for playback via broadcast, streaming or similar methods. Companion file 131 may reside on a separate storage medium, the same media 101 as entertainment content, or may be distributed with the entertainment media, e.g., by network connections such as FTP, streaming media, broadcast media or similar distribution methods. The audio and/or video content, additional content and companion files may also be temporarily retained on the same or different media type to facilitate playback. For example, audio content may be an off-the-shelf CD 101 and the additional content may be on the CD or the additional content may be on a separate CD. The audio content from CD 101 and the additional content may be stored or cached on local machine 109 to facilitate the speed of playback or the responsiveness of enhanced features. In another embodiment, the content may contain video and/or audio, such as a DVD or similar media.

In one embodiment, the companion file 131 may be placed on the same media as the audio and/or video content at the time of production or prior to the sale of the media. For example, a motion picture studio or distributor may manufacture and sell DVDs containing a movie and an appropriate companion file 131 for that movie. In one embodiment, this companion file 131 or additional content may be ‘unlocked’ and provide no obstacles to access by a user with a player. In another embodiment, the companion file 131 or additional content may be ‘locked’ or accessible under limited circumstances. A password or other security mechanism may be required to access the companion file 131 or additional content. A connection over a network to a server or similar gatekeeper may be required to access the companion file 131 or additional content. In one embodiment, additional payment to the studio or distributor may be required to obtain the password to access all or a portion of the additional content.

In one embodiment, display device 103 may be a cathode ray tube based device, liquid crystal display, plasma screen, digital projection system or similar device that is capable of interfacing with local machine 109. Local machine 109 may include a removable media reading device 105 to access the audio and/or video content of media 101. Reading device 105 may be a CD, DVD, VCD, DiVX or similar drive. In one embodiment, local machine 109 includes a storage system 107 for storing player software, decode/video software, companion source data files 131, local language library software 123, piracy protection software 121, user preferences and tracking software 119 and other resource files for use with player software. Local drive 107 may also store data and applications including content control 151, position tracking 153, and inference engine 155. Local drive 107 may also be a memory device such as ROM, RAM or similar device. Either media 101 or storage system 107 may be a CD, DVD, magnetic disk, hard disk, peripheral device, solid state memory medium, network connected storage medium or Internet connected device. In one embodiment, local machine 109 includes a wireless communications device 111 to communicate with remote control 115. Remote control 115 can generate input for player software to access language information and adjust playback of video content. Communication device 117 may connect local machine 109 to network 127 and server 135.

In one embodiment, piracy protection software 121 includes a system where audio and/or video content is uniquely identified to ensure that a user has a legal copy of that content. In one embodiment, companion file 131 or some portion thereof is encrypted or inaccessible until it is verified that the user has the proper permissions to access the file (e.g., a legitimate copy of audio and/or video content, registration with the language learning service and similar criteria). In one embodiment, piracy protection software 121 manages local copies of audio and/or video content and companion files 131 to ensure that a single local copy is used when authorized and deleted when authorization is lost or an authorized media is removed from system 100. In one embodiment, piracy software 121 determines if an authorized copy of the audio and/or video content is available by accessing it on media 101. In one embodiment, the piracy protection software may force the use of a network connection to allow access to additional content and to authenticate use of the content. If media 101 is not available access to a local copy may be limited or eliminated.

In one embodiment, server 135 may provide access for player software to global language library software and databases 113, web based downloadable content, broadcast and streaming content, and similar resources. In one embodiment, player software is capable of browsing web based content, supports chat rooms and other resources provided by server 135.

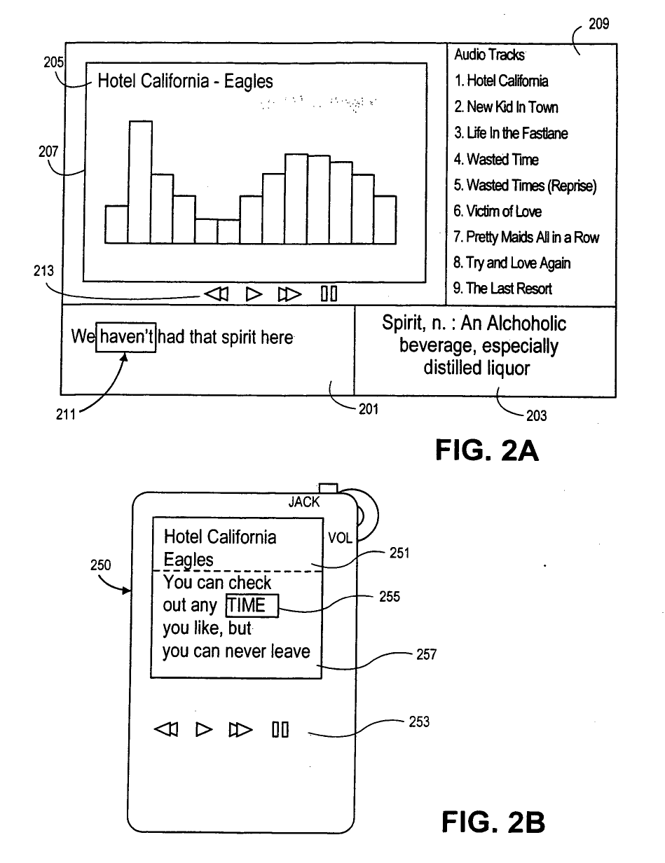

FIG. 2A is an exemplary illustration of player software for use in playing audio tracks, MP3's and similar formats. Similar player interfaces may be used for other audio and/or video data such as movies and similar content. In one embodiment, audio and/or video content is obtained from media 101, e.g., a CD or DVD in a local drive 105, and companion file 131 is obtained from a separate media, e.g., local hard disk 107. In another embodiment, the companion file 131 is located on media 101. In a further embodiment, the audio and/or video content and companion file 131 may be obtained over a network via file transfer protocol, streaming, or similar technology. Thus, for example, in one embodiment, an original audio content such as an MP3 file may be acquired over the Internet and an additional content file (companion file) may also be acquired over the Internet. The audio and/or video content may be accessed from the same source or a different source from companion file 131 over the network. Player software associates companion file 131 with the audio and/or video content during playback to augment the playback of audio and/or video content. The player software interface may include a window or viewing area 201 for displaying additional content such as the lyrics or words of an audio track. Words may be highlighted as they are spoken. Highlighting of words is deemed to include any visual mechanism to accent a part of the word text or viewing area surrounding the text. This may include, e.g., changing the color in a current word or background, underlining as words are spoken, shadowing as words are spoken, bolding the word being spoken, or similar techniques. Highlighting may be accompanied by a pointer 211 to the current word. In another embodiment, pointer 211 is used without highlighting. Other additional content derived from companion file 131 such as preamble and post amble material are discussed in detail below.

In one embodiment, companion file 131 will typically include additional content that may be used to augment the audio and/or video content during playback. The additional content may include without limitation any or all of an index of words spoken in the audio and/or video content in association with the frames or timepoints at which spoken, text in one or more languages that tracks a transcript of the audio and/or video content, definitions of any or all words used in an audio and/or video content with or without pronunciation aids, idioms used in audio and/or video content with or without definitions, usage examples for word and/or idioms, translations of existing subtitles, and similar content. Displayed text may include subtitles, dialogue balloons, and similar visual displays. Pronunciation aids may include text based pronunciation keys (e.g., use of phonetic spelling conventions) as found in conventional dictionaries or audio of “correctly” pronounced words previously recorded or generated by computer program.

In one embodiment, if a text version of the audio and/or video content exits, it may be processed directly to prepare a companion file 131. In another embodiment, transcripts for companion files may be generated by an automated process. Systems may utilize an optical character recognition utility to obtain a rough transcript using the subtitles associated with video content or a voice recognition utility for an audio track. A translation utility may then be used to translate the transcript into a desired language. A human editor could then review the output and correct errors. In another embodiment, the transcript for the companion file 131 may be prepared manually by an editor who reviews the original content.

In one embodiment, a human editor may use a syllable detection software application to review the content and correlate the text of the words with the points in the segment of the audio and/or video content where they are spoken. As used herein, the term “segment” denotes a portion of the content between two defined points. In another embodiment, the system may attempt to prepare the transcripts to be aligned with an audio and/or video content by estimating the approximate number of words spoken in a segment and distributing the words in the transcript across the time length of the segment. In one embodiment the words of the text pre-aligned in this manner may be reviewed to more accurately align the words of the text with the audio and/or video content. In one embodiment, databases of word meanings, idioms, and similar data are searched to categorize and check the generated transcripts.

In one embodiment, the player software provides a graphical user interface (GUI) to allow a user to drill deeper into the additional content. For example, a user may be able to click on a word in a caption and get a definition for the word from the dictionary in the companion file 131. The exemplary embodiment includes a window 203 for displaying additional content related to the audio and/or video content and transcription. A navigation facility may also be provided such that, e.g., clicking on a word in the dictionary will transport the user to the place(s) in the audio and/or video content where the word is used. In one embodiment, the player software may automatically recognize available media and access or retrieve related data such as artist name, publisher, chapter or track information and similar data. The player may allow a user to choose the method of or location of additional content to be used in conjunction with the player.

In one embodiment, the GUI may also provide the user the ability to repeat an arbitrary portion of the content viewed or heard. For example, soft buttons may be provided to cause a repeat of the previous line, previous lyric, dialogue exchange, scene, or similar segment of the audio and/or video content. The random access nature of both audio and/or video content and the additional content permits a user to specify to an arbitrary degree of granularity as to what portion of audio and/or video content and associated additional content to view or hear. Thus, a user may elect to view or hear a scene, dialogue exchange or merely a line within audio and/or video content. The ability to repeat with arbitrary granularity enhances the learning experience. The GUI may also provide the user the ability to control the speed and/or pitch of the audio and/or video to facilitate understanding of the spoken language. Speed may be adjusted by inserting spaces between words while maintaining the normal pitch and speed of the actual words spoken.

In one embodiment, the player supports full screen and windowed modes. In the full screen mode the player displays audio and/or video content according to the limits of the dimensions, for example aspect ratio, of audio and/or video content and the limitations of the display device. In one embodiment, the GUI includes a set of icons or navigational options 213. In one embodiment, icons or navigation options 213 allow a user to access additional language content by use of a peripheral input device such as a mouse, keyboard, remote control or similar device. In one embodiment, the playback options may be enabled or disabled as desired by a user.

In one embodiment, icons and navigation options link audio and/or video content to dictionaries, catalogs and guides and similar language reference and navigation tools. These links may cause the player to display specialized screens to show the user the relevant content. In one embodiment, an icon or navigation option links to an explanation screen that lists idioms in a segment of audio and/or video content in multiple languages. Specialized screens accessible through icons and navigation options 213 may also display information about word definitions, slang, grammar, pronunciation, etymology and speech coaching, as well as access menus, character information menus and similar features. In another embodiment, alternative navigation techniques are used to access special content such as hot keys, hyperlinks or similar techniques and combinations thereof. In one embodiment, when specialized screens are accessed, the audio and/or video content is minimized or reduced in size to create space in the display to view or hear the additional content while still allowing the viewing or listening to the audio and/or video playback if appropriate. Audio and/or video content acts as an icon or option to return to full screen mode when the user is finished reviewing the materials of the specialized screen. In another embodiment, audio and/or video content is not displayed while specialized content is displayed.

In one embodiment, a dictionary of words and/or idioms may be displayed on specialized screens accessible by icons, navigation option or directly highlighting or selecting displayed text. The dictionary data may be audio and/or video content specific. For example, it may include a definition of a word or idiom as used in a particular audio and/or video content but not all definitions of the word or idiom. The dictionary data may contain definitions and related words or idioms in a language other than the language of audio and/or video content. The dictionary data may include other data of interest that is general or unique to the particular audio and/or video content. Data of interest may include a translation of the word and/or idiom into another language, an example of a usage of a word, an association between an idiom and a word, a definition of an idiom, a translation of an idiom into another language, an example of usage of an idiom, a character in audio and/or video content who spoke a word, an identifier for a scene in which a word or idiom was spoken, a topic which relates to the scene in which a word or idiom was spoken or similar information. Such data may be retained in a database, flat file or companion source file segment with associated links to permit a user to jump directly to a relevant portion of audio and/or video content from the content in the database.

The player may have additional features dependent on the type of audio and/or video content being played. In the exemplary embodiment, the player may identify the title or section (e.g., track or scene) of the audio and/or video work with a caption 205. The player may list other sections 209 of the audio and/or video content for providing a title or label for each selection. The player may also generate a visual representation or accompanying graphic display 207 to accompany audio content.

FIG. 2B is an illustration of an exemplary portable player of audio content. In one embodiment, portable player device 250 may have stored audio content and companion files in an internal memory or portable storage device. Portable device 250 may be a scaled down version of system 100. In one embodiment, portable player 250 may have each of the components of system 100. In another embodiment, portable player 250 may have a reduced set of components including play options 253 and display 257. The display 257 may identify the content being played 251 and text associated with the content. Portable player may support highlighting 255 of the currently audible text. In one embodiment, the portable player may be a MP3 player, CD player, handheld device, a Personal Daily/Digital Assistant (PDA), cell phone, tablet PC or similar device. In a further embodiment, a similar portable video content viewer such as portable DVD players may also support a player with a full or reduced set of features.

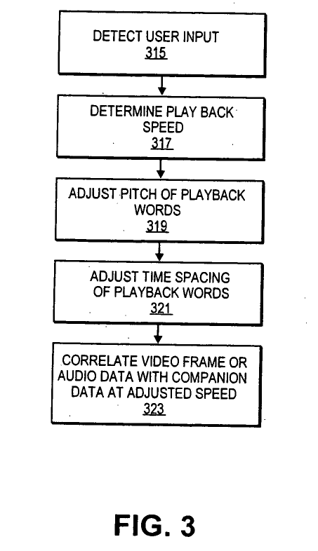

FIG. 3 is a flowchart illustrating the process of adjusting the playback of audio and/or video content. A user can adjust the playback of audio and/or video content including an audio portion associated with video content using a peripheral device connected either directly or wirelessly with local machine 109. A peripheral device may be a mouse, keyboard, trackball, joystick, game pad, remote control 115 or similar device. Player software receives input from peripheral device 115 (block 315). In one embodiment, player software determines that this input is related to the playback of audio and/or video content including determining the desired playback speed and start point for the playback (block 317). Player software queues the audio and/or video content to the desired start position and begins playback of audio and/or video content. Player software adjusts the playback rate of audio and/or video content in accordance with the input from the peripheral device.

In one embodiment, player software also adjusts the pitch of the words being spoken in the audio portion of the audio and/or video content (block 319). In one embodiment, player software adjusts the timing and spacing of the words being played back at the adjusted speed in order to enhance the discrete set of sounds associated with each word to facilitate the understanding of the words by the user (block 321). The time spacing is adjusted without affecting the pitch of the voice of the speaker. In one embodiment, player software correlates the data between content and the companion source data file at an adjusted speed, including displaying captions at the adjusted speed, highlighting words in the captions at an adjusted speed and similar speed related adjustments to the augmented playback (block 323). In one embodiment, the user can select a type of playback based on individual words, sentences, segment or similar manners of dividing the audio track of video content.

In one embodiment, peripheral device 115 provides input to player software that determines the type of adjusted playback to be provided. Upon receiving a first input (e.g., a click of a button) from peripheral input device 115, player software repeats a segment of audio and/or video content at normal speed. If two inputs are received in a predefined period then player software may replay an audio and/or video content segment at a slower rate using the time spacing and pitch adjustment techniques. If three inputs are received in the predefined period then player software may play back the audio and/or video content segment using audio from a library of clearly articulated words. If four input signals are received in the predefined time period then player may display drill-down screens related to the sentence in the relevant audio and/or video content segment. Drill-down screens may include phonetic, grammar and similar information related to the sentence and may be displayed in combination with the slowed audio or audio from the library. In a further embodiment use of icons, navigation options including input mechanisms of a player device may be used to initiate these adjusted playback features. In one embodiment, an input signal received during a predefined initial time period during the playback of a segment of audio and/or video content may initiate the playback of the previous segment of the audio and/or video content.

In one embodiment, player software includes a speech coaching subprogram to assist a user in correct pronunciation. The speech coaching program provides an interface that works in conjunction with the adjusted playback features to playback segments of the audio portion the audio and/or video content at a reduced speed to facilitate the user's understanding of the audio portion. In one embodiment, the speech coaching program allows a user with an audio peripheral input device (e.g., a microphone or similar device) to repeat the selected audio segment. In one embodiment, the speech coaching program provides recommendations, grading or similar feedback to the user to assist the user in correcting his speech to match speech from the audio portion. In one embodiment, the user can access a set of varying pronunciations that have been pre-recorded, listen to the pronunciation of a line by a character or listen to a computer voice reading of the relevant section of a transcript. In one embodiment, the correct phonetic pronunciation of a word or set of words is displayed. If a user records a pronunciation then the phonetic equivalent of what the user recorded will be displayed for comparison and feedback. The speech coaching program displays a graphical representation of the correct pronunciation such that the user can compare his recorded pronunciation to the correct pronunciation. This graphical representation may be, for example, a waveform of the recorded audio of the user displayed adjacent to or overlapping a correct pronunciation. In another embodiment, the graphical representative is a phonetic computer generated transcription of the recorded audio allowing the user to see how his pronunciation compares to a correct phonetic spelling of the words being recorded. The recorded user audio and correct pronunciation may also be displayed as a bar graph, color coded mapping, animated physiological simulation or similar representation.

In one embodiment, player software includes an alternative playback option that allows the transcript of an audio and/or video content to be played with another voice such as an actor's voice or a computer generated voice. This feature can be used in connection with the adjusted playback feature and the speech coach feature. This assists a user when the audio portion is not clear or does not use a proper pronunciation.

In one embodiment, player software displays an introduction screen, preamble screens and postamble screens attached at the beginning and end of audio and/or video content and segments of audio and/or video content. The introduction screen may be a menu that allows the user to choose the options that are desired during playback. In one embodiment, the user can select a set of preferences to be tracked or used during playback. In one embodiment, the user can select ‘hot word flagging’ that highlights a select set of words in a transcript during playback. The words are highlighted and ‘hint’ words may also be displayed that help explain or clarify the meaning of the highlighted word. In one embodiment, words that a user has difficulty with are flagged as ‘hot words’ and are indexed or cataloged for the user's reference. The user may enable bookmarking, which allows a user to mark a scene during playback to be returned to or indexed for later viewing or listening. In one embodiment, the introduction screen allows a choice of language, user level, specific user identification and similar parameters for tailoring the language learning content to the user's needs. In one embodiment, user levels are divided into beginning, intermediate, advanced and fluent. In another embodiment, these levels of users are based on a numerical scale, e.g., 1-5, with an increasing level of difficulty and expected fluency. Each higher level displays more advanced content or less assisting content than the lower levels. In one embodiment, an introduction screen may include advertisements for other products or audio and/or video content.

In one embodiment, preamble screens may be attached to the beginning of a segment of audio and/or video content (e.g., a song, or movie scene). In one embodiment, words and idioms associated with a segment may be displayed in a preamble screen. Words and information displayed will be in accord with the specified user level. In one embodiment, preamble screens introduce material before an audio and/or video segment including: words in the segment, word explanations, word pronunciations, questions relating to audio and/or video content or language, information relating to the user's prior experience and similar material. Links in the preamble allow a user to start playback at a specific frame. For example, a preamble may have a link between the preamble and a word occurring in the scene, to allow the user to jump directly to the frame in audio and/or video content in which the word is used. In one embodiment, a user may set preferences that prevent the display of some or all preamble screens, or show them only on reception of further input. In one embodiment, screen shots or other images or animations are used in the preamble screens to illustrate a word or concept or to identify the associated scene. In one embodiment, a set of pre-rendered images for use in preamble screens is packaged as a part of player software. In one embodiment, preamble screens are not displayed unless the user ‘opts-in’ to avoid disrupting the natural flow of audio and/or video content.

In one embodiment, preamble screens include specific words, phrases or grammatical constructs to be highlighted for the learning process. The relevant material from a companion file 131 related to a scene is compiled by player software. Player software analyzes the user level data associated with each data item in the scene and constructs a list of the relevant type of data that corresponds to the user level or meets user specified preferences or criteria. In one embodiment, additional material related to the scene may be added to the list such as “hot words” regardless of its indicated user level. Material that tracking data stored by player software indicates the user understands well or has already been tested on by previous preamble screens is removed from the list. Random or pseudo-random functions are then used to select a word, phrase, grammatical construct or the like from the assembled list to be used in the preamble screen. In another embodiment, the words or information displayed on a preamble screen is chosen by an editor or inferred from data collected about the user.

In one embodiment, the postamble screen is an interactive testing or trivia program that tests the user's understanding of language and content related to audio and/or video content. In one embodiment, questions are timed and correct and incorrect answers result in different screens or audio and/or video content being displayed. In one embodiment, if a timeout occurs, the correct answer is displayed.

In one embodiment, postamble material is at the end of a scene or audio and/or video content. In one embodiment, content and questions are generated automatically based on tracked user input during the viewing or listening to audio and/or video content. For example, segments of the audio and/or video content that the user had difficulty with based on a number of replays are replayed in order of difficulty during the postamble. In one embodiment, content from other audio and/or video content may be used or cross referenced with content from the viewed or heard audio and/or video content based on similar language content, characters, subject matter, actors or similar criteria. In one embodiment, postamble screens display language and vocabulary information including links similar to the preamble screen. Postamble screens may be deactivated or partially activated by a user in the same manner as preamble screens. In one embodiment, screen shots or other images or animations are used in the postamble screens to illustrate a word or concept or to identify the associated scene. In one embodiment, a set of pre-rendered images for use in postamble screens is packaged as a part of player software. Player software accesses companion file 131 to determine when to insert preamble and postamble screens and associated content. In one embodiment, all postamble screens are ‘opt-in’ except once the audio and/or video content has ended, e.g., at the end of the movie in which case the postamble will be supplied unless the user ‘opts-out’ by providing an input.

In one embodiment, as discussed above, player software tracks user preferences and actions to better adjust the augmented playback information to the user's needs. User preference information includes user fluency level, pausing and adjusted playback usage, drill performance, bookmarks and similar information. In one embodiment, player software compiles a customizable database of words as a vocabulary list based on user input.

In on embodiment, user preferences are exportable from player software to other devices and machines for use with other programs and player software on other machines. In one embodiment, server stores user preferences and allows a user to log in to server 135 to obtain and configure local player software to incorporate the preferences.

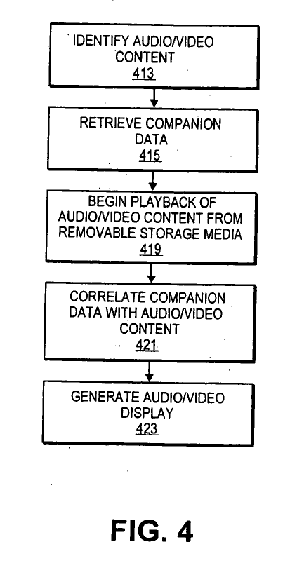

FIG. 4 is a flowchart of a player software process of correlating a companion file 131 to audio and/or video content. Player software identifies the audio and/or video content that the user wishes to view or hear (block 413). In one embodiment, player software accesses audio and/or video content to find an identifying data sequence and correlates that sequence to a companion file 131 using a local or remote database or by searching locally accessible companion file 131. Once audio and/or video content has been identified, player software determines if a copy of the appropriate companion source file is available locally.

In one embodiment, the companion file 131 may be stored on a removable media storage article such as a CD, DVD or similar storage media. In one embodiment, if companion file 131 is not available locally, player software accesses server 135 over network 127 to download the appropriate companion source file. In one embodiment, companion file 131 for the audio and/or video content my also be located on the same media, transmitted in coordination with the audio and/or video content or transmitted from the same remote storage location. In a further embodiment, companion file 131 may be stored on a local drive 105 or storage device 107. The player may identify the appropriate companion file 131 by its co-location with the audio and/or video content (block 415). In one embodiment, player software then begins the access and playback of audio and/or video content (block 419). As used herein, the term media is used to refer to articles, conduits and methods of delivering content such as CDs, DVDs, network streams, broadcast and similar delivery methods. References to two items being on the same medium indicate that the two items are on the same article or stream (e.g., single instance of media) and references to items being on the same type of media indicate the two items may be on one or more articles, such as a pair of CDs or a pair of DVDs or network streams (or could be on a single medium).

In one embodiment, the player software correlates audio and/or video content and companion file 131 on a frame by frame or timepoint by timepoint basis (block 421). In one embodiment, companion file 131 contains information about audio and/or video content based on a set of indices associated with each frame or timepoint in audio and/or video content in a sequential manner. Player software, based on the frame or timepoint of audio and/or video content being prepared for display, accesses the related data in companion file 131 to generate an augmented playback. Related data may include transcripts, vocabulary, idiomatic expressions, and other language related materials related to the dialogue of audio and/or video content.

In one embodiment, companion file 131 may be a flat file, database file, or similar formatted file. In one embodiment, companion file 131 data is encoded in XML or a similar computer interpreted language. In another embodiment, companion file 131 will be implemented in an objected-oriented paradigm with each word, line, scene instance and similar segments represented by an instance of an object of an appropriate class.

In one embodiment, the player uses companion file 131 data to augment the playback of audio and/or video content (block 423). The augmentation may include a display of text, phonetic pronunciations, icons that link to additional menus and features related to audio and/or video content such as guides, menus, and similar information related to audio and/or video content. In one embodiment, other resources available through player software and companion file 131 include: grammatical analysis and explanation of sentence structures in the transcript, grammar-related lessons, explanation of idiomatic expressions, character and content related indices and similar resources. In one embodiment, player would access an initial line or scene section and use the information therein to find the starting position in the word index and the corresponding starting frame. Playback would continue sequentially through each section unless diverted by user input requesting access to specific information or jumping to a different position in the audio and/or video content.

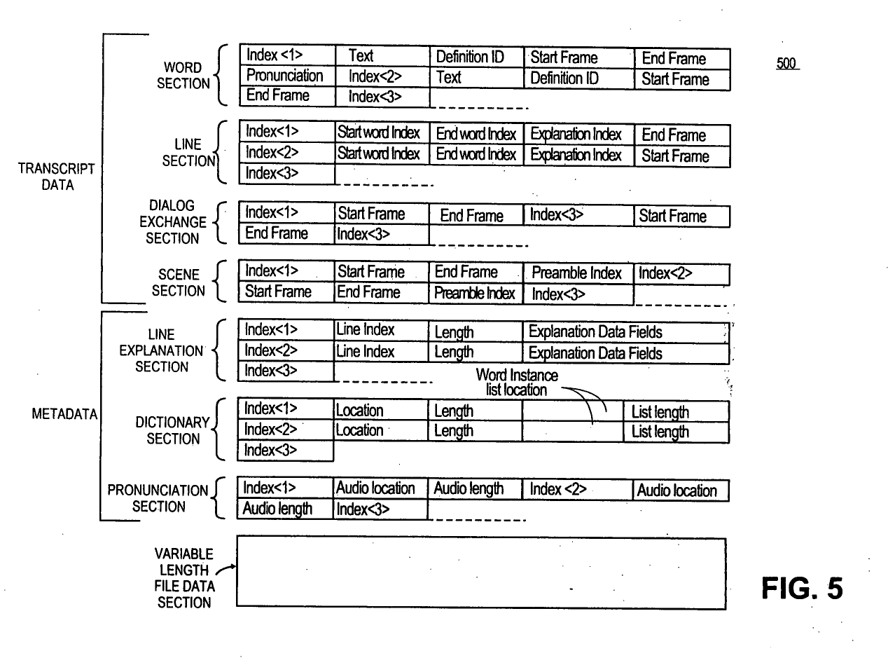

FIG. 5 is a diagram of a exemplary companion file format. In this embodiment, companion file 131 is configured for use with audio and/or video content such as movies, audio books, television shows, and similar performances. In one embodiment, companion file 131 is divided into transcript related data and metadata. In one embodiment, transcript related data is primarily sequentially stored or indexed data including data related to the transcript including words, lines and dialog exchanges as well as scene related data. Metadata is primarily secondary or reference related data accessed upon user request such as dictionary data, pronunciation data and content related indices.

In one embodiment, transcript data is stored in a flat sequential binary format 500. Flat format 500 includes multiple sections related to the transcript grouped according to a defined hierarchy. The data in each section is organized in a sequential manner following the sequence of the transcript. In one embodiment the fields in the format have a fixed length. In one embodiment, the sections include a word section, line section, dialog exchange section, scene section and other similar sections. The word section includes a word instance index that identifies the position of the word in the word section sequence, the word text, a word definition identification or pointer to link the word to definition data, a pronunciation identification field or pointer to link the word to related pronunciation data and starting and end frame fields to identify the starting and ending frames from audio and/or video content that the word is associated with. In one embodiment, the line section includes a line index that identifies the position of each line in the line section sequence, a starting word index to indicate the first word in the word section that is associated with the line, an ending word index to indicate the last word associated with the line, a line explanation index to indicate or point to data related to the language explanation of the line of the transcript, a character identification field to point to or link the line with a character in the audio and/or video content, starting and ending frame indicators and similar information or pointers to information related to the line. In one embodiment, the dialog exchange section includes an exchange index to identify the position in the index of the dialogue exchange section a starting frame and an ending frame associated with the dialogue exchange and similar pointers and information. In one embodiment, the scene section includes an index to identify the position of a scene in the scene section, a preamble identification field or pointer, a postamble identification field or pointer, starting and end frames and similar indicators and information related to a scene.

In one embodiment, the metadata sections include a line explanation section, a word dictionary section, a word pronunciation section and similar sections related to secondary and reference type information related to audio and/or video content and language therein. In one embodiment, an explanation section would include an index to indicate the position of the line explanation in the line explanation section, a line index to indicate the corresponding line, a set of explanation data fields related to the various types of grammatical and semantic explanation data provided for a given line and similar fields related to data corresponding to a line explanation. In one embodiment, the word pronunciation section includes an index to indicate the position of an instance in the word pronunciation section, a pointer to audio data, a length of audio data field, an audio data type field and similar pronunciation related data and pointers.

In one embodiment, pointers are used in fields to indicate data that is larger than the field size in the binary file. This allows flexibility in the size of data used while maintaining a standard format and length for the fields in the binary file. In one embodiment, companion file 131 have alternate formats for editing and file creation such as XML and other markup languages, databases (e.g., relational databases) or object oriented formats. In one embodiment, companion file 131 are stored in a different format on server 135. In one embodiment, companion file 131 are stored as relational database files to facilitate the dynamic modification of the files when being created or edited. The databases are flattened into a flat file format to facilitate access by player software during playback.

In another embodiment, the companion file 131 format may be modified or redefined for other content types such as albums, songs, music videos, educational material, documentaries, interviews and similar content. For example, a companion file 131 for an album may be organized based on time points in track instead of scenes and lines. Companion file 131 intended for use on portable devices may have a reduced set of fields based on the capabilities of the portable player device. For example a field relating to pronunciation or detailed analysis of the transcript may be omitted or ignored.

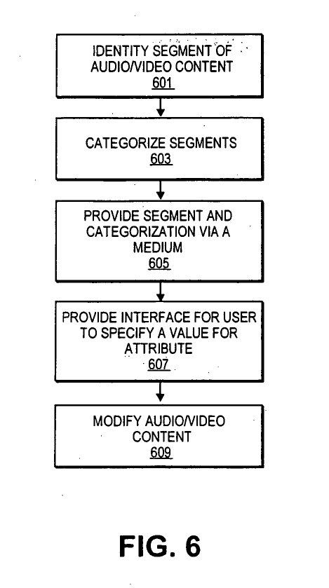

FIG. 6 is a flowchart of the operation of a content control system. In one embodiment, the content control system may allow a user to select the type of content in the audio and/or video content to filter or alter. For example, a parent may want to filter the profane language of a movie or song which their child is about to view or hear. This control content system may be used in the context of a language learning system or may be used to control content during the conventional viewing or listening to entertainment and similar media.

The content control system functions based on a companion file 131 that contains information that categorizes the words and phrases of the transcription associated with the audio and/or video content. Companion file 131 used only with the content control system may have a specialized format that includes the indexed transcript and categorization of the words and phrases but may omit other data and fields related to other enhanced features. Companion file 131 may be optimized for random or sequential access. In another embodiment, the indexing of additional content in companion file 131 may not be based on the transcript but may be based on frame, a time reference or similar method of indexing an audio and/or video content. In one embodiment, such indexing facilitates non-verbal content control, such as, e.g., nudity.

The content control system depends on the companion file 131 containing an identification of the categories of each of the segments, words and phrases in the transcript for the audio and/or video content (block 601). Each segment, word, phrase or similar portion of the transcript may be categorized based on whether it is related to sexual content, violent content, profane content, immoral content or similar content that a user may desire to filter (block 603). The companion file 131 with the category data and transcript may be provided on the same media, separate media or through the same or separate distribution method (block 605) to a local machine of a user having a player program. Companion file 131 may contain attributes associated with words, frames, or segments of the media. For example, an attribute assigned for word may be a numerical rating indicating a level of objectionability.

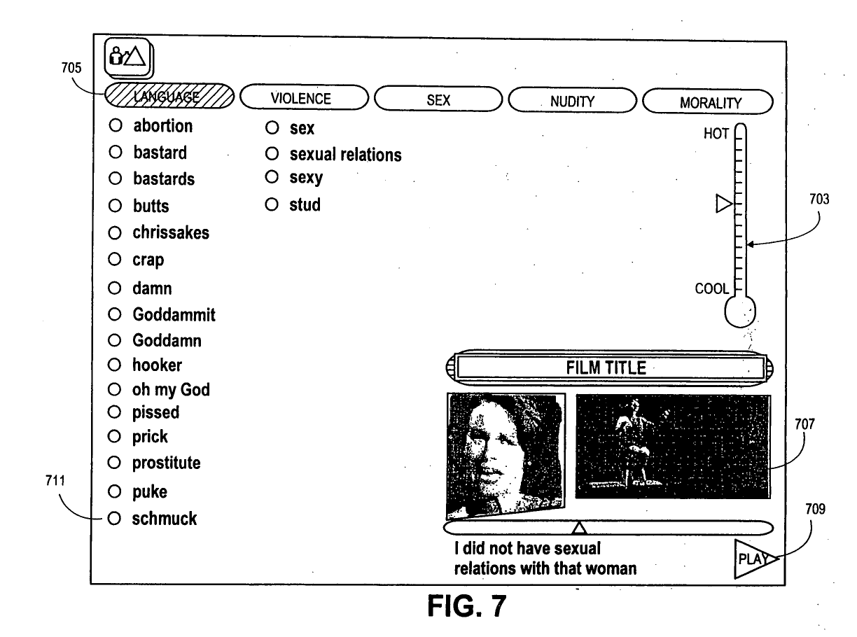

A user may determine the set of content to be filtered using an interface provided by the player (block 607). FIG. 7 is an exemplary interface screen for the content control system. The interface screen includes a set of navigation options or icons 705 to select the set of categories that the user desires to view, hear or alter. In the example interface, the content is divided into language, violence, sex, nudity, and morality categories. The interface screen for the language screen shown includes a list of the words or phrases that are associated with the selected category. In the example interface screen, all the words and phrases in the language, in this example referring to profane language, are displayed. A user may select words or phrases displayed or to be, for example, omitted during playback. In one embodiment, the selection triggers a Boolean value that flags whether or not to playback, alter or similarly censor a word, phrase, scene or similar portion of audio and/or video content when the filter is activated. In another embodiment, a more granular selection may allow the user to apply a range of options that may affect the filtering of audio and/or video content. Some of examples of possible options include to mute a segment, skip a segment, skip a related segment and similar possible censoring techniques.

In the example interface screen, in one embodiment, selection may be accomplished through a sliding indicator 703. As the slider is moved toward “cool” the threshold for objectionability becomes lower. Thus, at the extreme low and all objectional words would be omitted. If we imagine a profanity scale between zero and ten with ten being the most profane, words having a profanity attribute greater than five will be selected for alteration when the slider is in the middle. Similar attribute ratings may be assigned in connection with the other categories. In one embodiment, the radio button next to the words change as the slider moves so a user can see the effect of the move in the slider on selection. In one embodiment, an attribute may be a value associated with a word or phrase (scene, frame, or segment) for a particular category that identifies the conditions that the word or phrase may be filtered under. Attributes are typically contained within the companion file 131, but in some embodiments may be user defined.

In the example screen interface a sliding bar indicator 703 ranging from ‘hot’ to ‘cool’ can be used to set the filter level for a group or category of words. The information regarding the attribute value and the position of the sliding bar indicator 703 for a group of words or phrases may be used by the player software in conjunction with other information such as the identity of a current user, time of day, content type (e.g., music or video) and similar data that may affect which level of filtering is appropriate.

The interface screen may have additional features to facilitate the selection of content for modification. In one embodiment, the interface screen may include a viewing screen 707 to view or listen to a segment of the audio and/or video content in which a word or phrase occurs. If the content is audio only then a visual representation may accompany the audio. For example, a user may select the word ‘abortion’ from the list of words in the category ‘language.’ The segment of the movie or music in which this word occurs may then be queue for review in the viewing screen 707. The interface screen may also include navigation option and icons 709 to resume play or access additional information or options.

In one embodiment, during playback the player continually checks the current segment being played to determine if a filter should be applied to the word or phrase that is about to be played (block 609). In one embodiment, the player may skip over a scene or segment of the audio and/or video content that includes the content to be filtered. In another embodiment, the content may be blurred, muted, bleeped or censored in a similar manner that obstructs the viewing or hearing of the filtered content. In one embodiment, the player software allows the user to select from these options for filtering different categories or instances of a word or phrase to be filtered. User preferences may be saved for later use. The preferences may be tied to a single content or generalized over categories of content. A user may completely disable the content control. In one embodiment, the ability to disable the controls is restricted to a master user and may have password protection or similar protection.

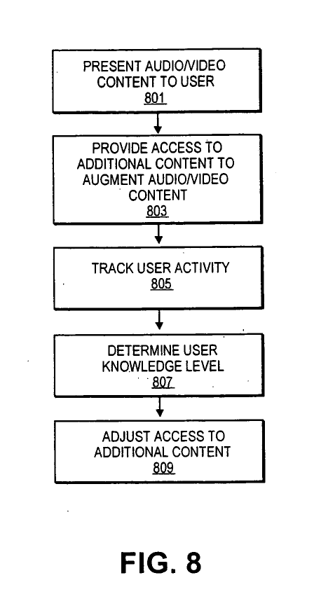

FIG. 8 is a flowchart of an inference engine for enhancing the quality of the learning experience for a user viewing or listening to an audio and/or video content for the purpose of language learning. In one embodiment, the player may track user input related to the playback of the audio and/or video content. The player starts by presenting the audio and/or video content to the user in a default playback mode or according to the current settings of the player (block 801). The player also provides access to additional content based on a default level of user competency or the current estimated level of language competency of the user (block 803).

In one embodiment, during the playback of the audio and/or video content and the additional content the player tracks the type of responses and input of the user (block 805). The types of input and responses tracked may include the number of times that a user backtracked the play of a particular word, phrase or segment of the audio and/or video content, the speed at which the user viewed or listened to a segment, the responses to questions provided by the user, time spent using help information responses to prompt or questions biofeedback such as infrared camera readings, controller usage, user movement, restlessness, and similar information and data. The inference engine analyzes the collected data to determine the level of knowledge of the subject language for the user (block 807).

In one embodiment, this determination of the competency of a user in the language is then used to select or adjust the settings of the presentation of the audio and/or video content to the user. The inference engine may utilize variable weighting and similar calculations to assess user competency. The inference engine may be implemented as an expert system, neural net or similar system. In one embodiment, the inference engine may be designed or trained for use by users of different linguistic and cultural backgrounds.

In one embodiment, the player may alter the speed at which it plays certain words or phrases, may change the type or number of questions in the preamble or postamble segments, may change the display of the transcript, alter the level of background music, offer additional content, provide an animated character, provide vocalization of the text of the transcript with different inflections, provide dictionary definitions and similar actions that may adjust the playback to fit the learning needs of the user. In one embodiment, during the playback of audio and/or video content voiceovers may be provided to assist a user in the comprehension of the content. A voiceover may be a vocalization of the text of the transcript, an explanation of the content (e.g., an explanation of a scene, dialog exchange, concept, phrase, word or similar content) or similar material that is provided in companion file 131. Other adjustments to the playback may include adjusting volume of various aspects of the audio (e.g., background music, dialog and similar audio tracks), muting, speed adjustment, pausing and similar actions. Users who are determined to have a high level of competency will generally receive less assistance or more complex assistance and users with a lower level of competency will generally receive more assistance and simpler types of assistance.

A user may override the setting of the inference engine and elect to obtain assistance at a higher or lower competency level. In one embodiment, the system stores inference engine tracking and state data for future use. The data and state may be used for future use of a particular content or used as a general template with new content. The stored data may include weighting factors, neural connections data, history logs and similar data.

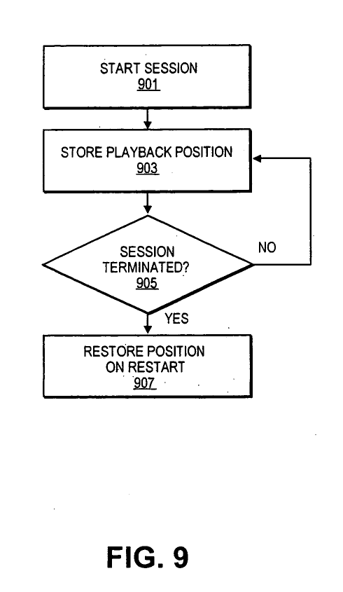

FIG. 9 is a flowchart of a system for tracking the playback position of the player. The tracked playback session position information may be used to maintain a ‘bookmark’ for a user to continue from a spot in the audio and/or video content where he or she left off at an earlier time. This system begins at the start of a session (block 901). A session as used herein may be a time period where a user starts the playback of an audio and/or video content until that playback is halted. The playback may be halted by direct selection of a user or through some system failure or similar occurrence such as a power loss. The playback monitoring system stores the playback position at regular intervals (block 903). In one embodiment, the intervals may be less than thirty second intervals. In one embodiment, the interval is less than one second. In some embodiments, the state of the system is stored at each interval. State storage may be accomplished by storing the delta of the state since the last interval. As long as the playback during the session continues, the playback monitoring system may continue to store the playback position at regular intervals (block 905). In one embodiment, if the playback is interrupted or terminated, on restart of the playback the playback will be resumed automatically at the point at which it left off previously (block 907). A user may opt out by utilizing a peripheral device or similar input device. The user may alter the automatic restart through a preference setting. In another embodiment, if the playback is interrupted or terminated, upon the restart of the playback or start of a new session the player may offer to start the playback at the last saved position. In a further embodiment, the restart of playback may start at a point in the audio and/or video content slightly before the last played point. The playback may also begin at the beginning of the current segment, after the end of a previous sentence or dialog exchange or at a similar starting point. In one embodiment, an amount of time elapsed since the last playback session may be factored into the determination of where play should be restarted. For example, beginning at the start of the most recent sentence may be sufficient if playback was interrupted by, e.g., a two minute telephone call. But, it may be desirable to return to the beginning of, e.g., the current dialogue exchange if days have passed.

In one embodiment, the player utilizes a special memory or storage device to track the playback position. In another embodiment, a device separate from the player may manage the storing of the playback position. The storage memory may be non volatile memory such as an EPROM, flash memory, battery backed up RAM or similar memory device, a fixed disk optical medium, magnetic medium, physical medium, or similar storage device. The position of the playback may be determined by the time point of the playback relative to the start of audio and/or video content, by use of an index, segment identification information or similar position identification information. In one embodiment, the system may store multiple playback positions. The playback position for different audio and/or video content may be stored simultaneously. In one embodiment, additional state information for the system may be tracked and stored including additional material playback position, inference engine, change logs, current settings and preference and similar data.

In one embodiment, the player application, server application and other elements are implemented in software (e.g., microcode, assembly language or higher level languages). These software implementations may be stored on a machine-readable medium. A “machine readable” medium may include any medium that can store or transfer information. Examples of a machine readable medium include a ROM, a floppy diskette, a CD-ROM, a DVD, flash memory, hard drive, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. A method comprising:
defining a segment within at least one of an audio and video digital content;
assigning at least one attribute to the segment;
delivering the segment and an attribute assignment information via a same type of media;
providing an interface to accept a user specification relating to the attribute; and
providing access to modify presentation of the media consistent with the specification.

2. The method of claim 1 further comprising:
indexing a plurality of segments according to attributes of the segments.

3. The method of claim 2 further comprising creating a database relating the segments and attributes.

4. The method of claim 1 further comprising linking additional content to the segment.

5. The method of claim 1 wherein the attribute relates to at least one of violent content, sexual content, nudity, and language content.

6. The method of claim 2 further comprising:
providing a review feature to allow a presentation of content based on the specification.

7. The method of claim 1, further comprising:
providing additional content that includes an index of words spoken in a soundtrack of the audio and video digital content;
adjusting a speed of playback of at least one of the audio and video digital content responsive to a user input;
adjusting at least one of pitch and time-spacing of the words to improve at least one of intelligibility and recognition; and
maintaining a correlation of words spoken to specific points in at least one of the audio and video digital content by reference to the index.

8. The method of claim 1, further comprising:
providing additional content that includes an index of words spoken in the audio or video content;
providing a library of audible pronunciations for a plurality of the words in the index; and
playing the pronunciations in response to a user input.

9. The method of claim 1, further comprising:
analyzing at least one of a user input, a context of the user input, a database of the audio and video digital content, a database of an additional content, and a database of user information to identify information of interest in relation to a segment of the audio or video digital content; and
presenting the information of interest prior to playing the segment.

10. The method of claim 1 further comprising:
analyzing at least one of a user input, a context of the user input, a database at least one of the audiovisual digital content, a database of an additional content, and a database of user information to identify information of interest in relation to a segment of at least one of the audio and video digital content; and
prompting the user for an additional input, the additional input to cause a further modification of the playback.

11. The method of claim 1 further comprising:
providing a link to other content accessible across a distributed network.

12. The method of claim 1 further comprising:
controlling access to at least one of content and functions based upon rights granted to the user.

13. The method of claim 12 wherein rights are granted based on payments received.

14. A method comprising:
storing in a nonvolatile memory a most recently played point in the playback of a passively playable video content;
allowing the termination of the playback session; and
returning to the same point in the playback upon subsequent playback of the same content.

15. A machine readable medium, having stored therein a set of instructions, which when executed cause a machine to perform a set of operations comprising:
obtaining an original content comprising at least one of a video and audio passively playable content;
delivering the original content with additional content including a text database of a plurality of words present within the original content via a same type of digital medium;
storing in a nonvolatile memory a most recently played point in the playback of the original content;
allowing the termination of the playback session; and
returning to a defined point in the playback upon subsequent playback of the same content wherein the defined point is determined based on an analysis of the content.

16. The machine readable medium of claim 15 wherein the defined point precedes the last point of playback and is determined by locating the beginning of at least one of a sentence, dialogue exchange, scene, topic or other logical segment of content.

17. The machine readable medium of claim 15 wherein the defined point precedes the last point of playback is determined by considering the time elapsed since the last playback session.
